(19) United States
(12) Patent Application Publication
(10) Pub. No.: US 2021/0176395 A1
(43) Pub. Date: Jun. 10, 2021

(54) GIMBAL SYSTEM AND IMAGE PROCESSING METHOD THEREOF AND UNMANNED AERIAL VEHICLE

(71) Applicant: SZ DJI TECHNOLOGY CO., LTD., Shenzhen (CN)

(72) Inventors: Qingbo LU, Shenzhen (CN); Zhenguo LU, Shenzhen (CN)

(21) Appl. No.: 17/180,572

(22) Filed: Feb. 19, 2021

Related U.S. Application Data
(63) Continuation of application No. PCT/CN2018/102000, filed on Aug. 23, 2018.

(51) Int. Cl. H04N 5/232; G03B 17/56; G06T 3/40; B64C 39/02

(52) U.S. Cl. CPC H04N 5/23229; H04N 5/23296; G03B 17/561; B64C 2201/123; G06T 3/4007; B64C 39/024; B64C 2201/127; G06T 3/4038

(57) ABSTRACT

An image processing method includes controlling a zoom lens carried by a gimbal to capture a reference image at a first focal range, adjusting the zoom lens to a second focal range, controlling the zoom lens to capture a plurality of far-focus images of different photographing ranges at the second focal range, stitching the plurality of far-focus images to form a stitched image, and processing the reference image and the stitched image to obtain a target reconstructed image. A focal length of the zoom lens corresponding to the second focal range is greater than a focal length of the zoom lens corresponding to the first focal range.

### CROSS-REFERENCE TO RELATED APPLICATION

This application is a continuation of International Application No. PCT/CN2018/102000, filed Aug. 23, 2018, the entire content of which is incorporated herein by reference.

### TECHNICAL FIELD

The present disclosure generally relates to the image processing technology field and, more particularly, to a gimbal system, an image processing method of the gimbal system, and an unmanned aerial vehicle (UAV).

### BACKGROUND

Super-resolution image reconstruction technology is a type of technology to obtain a high-resolution image from a low-resolution image. The super-resolution reconstruction image technology may be classified into two types: reconstructing the high-resolution image from a plurality of low-resolution images and reconstructing the high-resolution image from a single low-resolution image. A super-resolution reconstructed image provides more image details than an original image. Therefore, the super-resolution image reconstruction technology is broadly used in the field of security, medical treatment, etc.

Currently, the super-resolution reconstruction technology includes two types of algorithms, one being based on a single image and another being based on a plurality of images. These algorithms basically use a manner of building a model for training first and then estimating and predicting to reconstruct the high-resolution image. The effect of the super-resolution reconstruction is improved with the rapid development of deep learning. However, differences still exist between reconstructed details and a real scene by using these methods to obtain the reconstructed high-resolution image, and a reconstructed result has a poor visual effect in some scenes.

### SUMMARY

Embodiments of the present disclosure provide an image processing method includes controlling a zoom lens carried by a gimbal to capture a reference image at a first focal range, adjusting the zoom lens to a second focal range, controlling the zoom lens to capture a plurality of far-focus images of different photographing ranges at the second focal range, stitching the plurality of far-focus images to form a stitched image, and processing the reference image and the stitched image to obtain a target reconstructed image. A focal length of the zoom lens corresponding to the second focal range is greater than a focal length of the zoom lens corresponding to the first focal range.

Embodiments of the present disclosure provide a gimbal system including a gimbal, a zoom lens, and a processor. The zoom lens is carried by the gimbal. The processor is configured to control the zoom lens to capture a reference image at a first focal range, adjust the zoom lens to a second focal range, control the zoom lens to capture a plurality of far-focus images of different photographing ranges at the second focal range, stitch the plurality of far-focus images to form a stitched image, and process the reference image and the stitched image to obtain a target reconstructed image. A lens focal length of the zoom lens corresponding to the second focal range is greater than a lens focal length of the zoom lens corresponding to the first focal range.

Embodiments of the present disclosure provide an unmanned aerial vehicle (UAV) including a vehicle body and a gimbal system. The gimbal system is arranged at the vehicle body and includes a gimbal, a zoom lens, and a processor. The zoom lens is carried by the gimbal. The processor is configured to control the zoom lens to capture a reference image at a first focal range, adjust the zoom lens to a second focal range, control the zoom lens to capture a plurality of far-focus images of different photographing ranges at the second focal range, stitch the plurality of far-focus images to form a stitched image, and process the reference image and the stitched image to obtain a target reconstructed image. A lens focal length of the zoom lens corresponding to the second focal range is greater than a lens focal length of the zoom lens corresponding to the first focal range.

### BRIEF DESCRIPTION OF THE DRAWINGS

FIG. 1 is a schematic structural diagram of a gimbal system according to some embodiments of the present disclosure.

FIG. 2 is a schematic flowchart of an image processing method of the gimbal system according to some embodiments of the present disclosure.

FIG. 3 is a schematic diagram showing a reference image photographed by a zoom lens at a first focal range according to some embodiments of the present disclosure.

FIG. 4 is a schematic diagram showing a plurality of far-focus images of different photographing ranges photographed by the zoom lens at a second focal range according to some embodiments of the present disclosure.

FIG. 5 is a schematic diagram showing stitching the plurality of far-focus images of an area to form a stitched image of the area according to some embodiments of the present disclosure.

FIG. 6 to FIG. 11 are schematic flowcharts of the image processing method of the gimbal system according to some embodiments of the present disclosure.

FIG. 12 is a schematic structural diagram of an unmanned aerial vehicle (UAV) and the gimbal system according to some embodiments of the present disclosure.

### DETAILED DESCRIPTION OF THE EMBODIMENTS

Embodiments of the present disclosure are described in detail below. Examples of embodiments are shown in accompanying drawings. Same or similar characters represent same or similar elements or elements with same or similar functions. The description of embodiments with reference to the accompanying drawings are exemplary, which is merely used to explain the present disclosure and cannot be understood as a limitation of the present disclosure.

In the specification of the present disclosure, terms of “first” and “second” are merely used for descriptive purposes and should not be understood as indicating or implying relative importance or implicitly indicating a number of the indicated technical features. Therefore, a feature associated with “first” or “second” may explicitly or implicitly include one or more of such feature. In the specification of the present disclosure, “a plurality of” means two or more than two, unless otherwise specified.

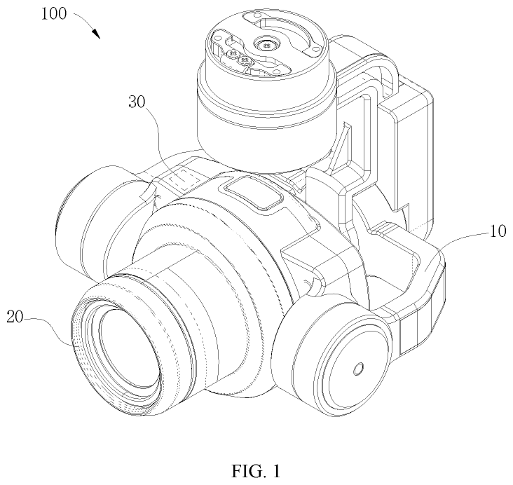

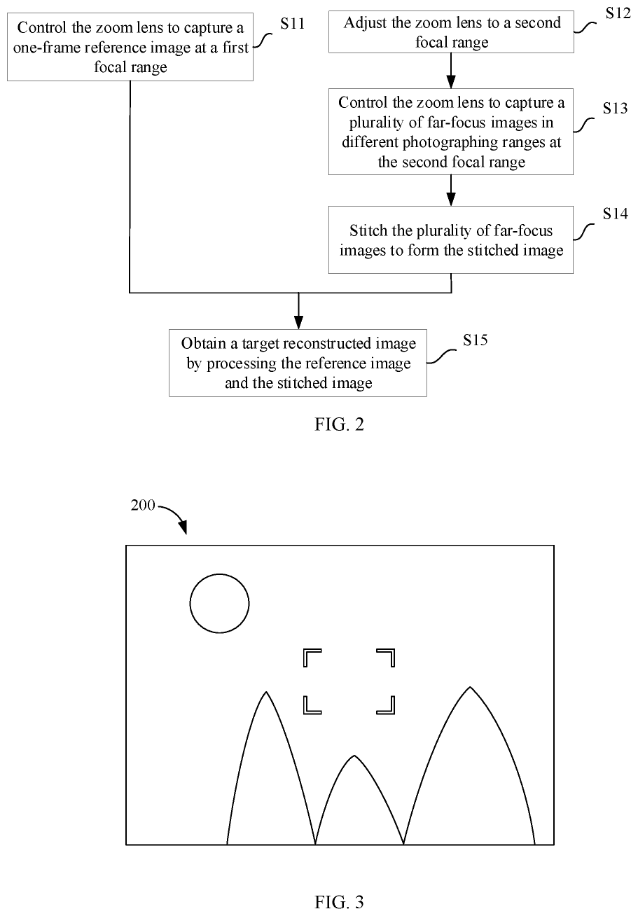

As shown in FIG. 1 and FIG. 2, embodiments of the present disclosure provide an image processing method of a gimbal system 100. The gimbal system 100 includes a gimbal 10 and a zoom lens 20 carried by the gimbal 10. The image processing method includes the following processes.

At S11, the zoom lens 20 is controlled to capture a reference image at a first focal range. The first focal range is an expected photographing focal range of a user.

At S12, the zoom lens 20 is adjusted to a second focal range.

At S13, the zoom lens 20 is controlled to capture a plurality of far-focus images in different photographing ranges at the second focal range. The lens focal length corresponding to the second focal range is greater than the lens focal length corresponding to the first focal range.

At S14, the plurality of far-focus images are stitched to form the stitched image.

At S15, a target reconstructed image is obtained by processing the reference image and the stitched image.

In some embodiments, an attitude of the gimbal 10 may follow a motion attitude of an imaged object. The gimbal 10 may include one or a plurality of axes. When the gimbal 10 includes only one axis, the gimbal 10 is a single-axis gimbal. When the gimbal 10 includes a plurality of axes, the gimbal 10 is a multi-axis gimbal. The multi-axis gimbal 10 may include a two-axis gimbal, for example, a gimbal including a yaw axis and a roll axis, or a gimbal including the yaw axis and a pitch axis. The multi-axis gimbal 10 may also include a three-axis gimbal, which may include the yaw axis, the roll axis, and the pitch axis. In embodiments of the present disclosure, a three-axis gimbal is described as an example of the gimbal 10.

The zoom lens 20 may change the focal length in a certain photographing range. Under different focal lengths, the zoom lens 20 may have a view angle of different sizes, a field of view of different sizes, and a photographing range of different sizes. Thus, a photographing range of a scene covered by images captured at different focal lengths may be different (i.e., the photographing range is different). In some embodiments, the zoom lens 20 may include an optical zoom lens, a digital zoom lens, or a combination of a plurality of types of zoom lenses. The zoom lens 20 may be carried by the gimbal 10. Thus, the zoom lens 20 may follow the imaged object in real-time. In some embodiments, the zoom lens 20 may rotate relative to the yaw axis, the roll axis, and the pitch axis of the gimbal 10. When one or two axes of the gimbal 10 are locked, the zoom lens 20 may rotate following the other one or two axes. For example, when the roll axis and the pitch axis are locked, the zoom lens 20 may only rotate relative to the yaw axis. The zoom lens 20 of embodiments of the present disclosure may capture an image at the first focal range or be switched from the first focal range to the second focal range to capture an image at the second focal range. The first focal range may include a photographing focal length expected by the user. Within the first focal range, the corresponding lens focal length is relatively small, a view angle photographed by the zoom lens 20 may be relatively large, a main object photographed by the zoom lens 20 may be relatively small, and a depth of field photographed by the zoom lens 20 may be relatively long. The lens focal length corresponding to the second focal range may be greater than the lens focal length corresponding to the first focal range. Within the second focal range, the lens focal length corresponding to the second focal range may be relatively large, the view angle photographed by the zoom lens 20 may be relatively small, the main object photographed by the zoom lens 20 may be relatively large, and depth of field photographed by the zoom lens 20 may be relatively short.

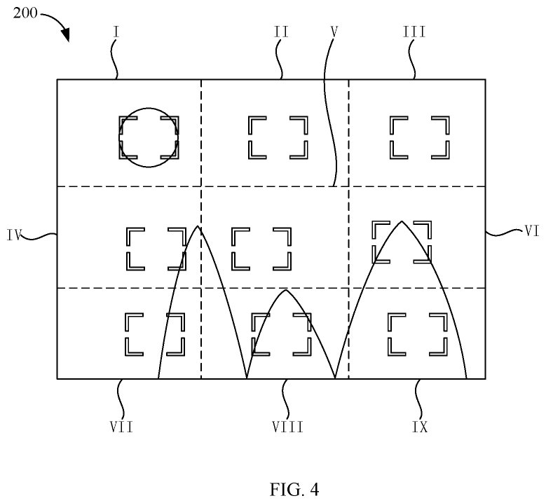

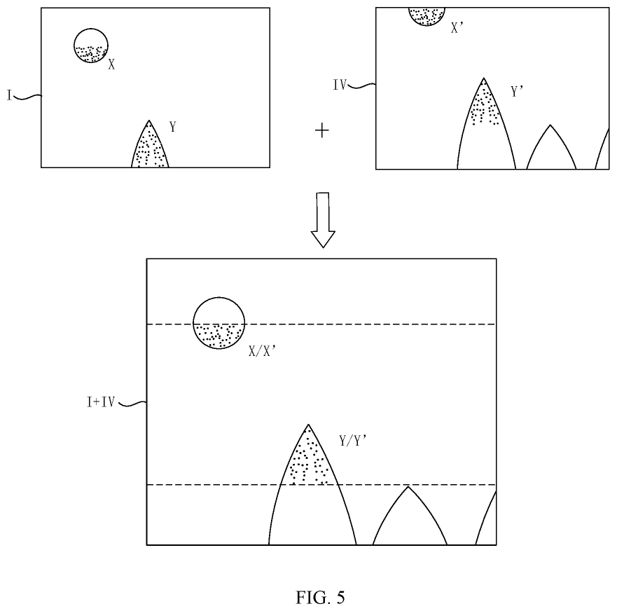

In connection with FIG. 3, in the image processing method of embodiments of the present disclosure, a to-be-imaged object, for example, a person, an animal, a scene, etc., is determined first in a target scene 200. In process S11, the zoom lens 20 is controlled to capture the reference image at the first focal range. The view angle of the reference image may be relatively large, and the main object of the reference image may be relatively small and have a relatively low resolution. In process S13, the zoom length 20 is controlled to capture the plurality of far-focus images in different photographing ranges at the second focal range. In some embodiments, the plurality of far-focus images may include two or more images. In addition, the different photographing ranges may represent that the zoom lens 20 may focus on a plurality of different areas in the target scene 200 to obtain clear images of the plurality of different areas. As shown in FIG. 4, the zoom lens 20 is focused on nine areas of the target scene 200 at the second focal range. For example, in area I, the zoom lens 20 is focused on the sun, and in area VI, the zoom lens 20 is focused on a peak of a third mountain from the left. The lens focal length of the zoom lens 20 focused on each area may be the same or slightly different but within the photographing range of the second focal range. After the zoom lens 20 is configured to photograph at the second focal range, nine far-focus images of nine different photographing ranges may be obtained. Each of the nine far-focus images may display detail of at least one area of the target scene 200. In process S14, after the plurality of far-focus images are obtained, the plurality of far-focus images are stitched to form the stitched image. As shown in FIG. 5, the far-focus image of area I and the far-focus image of area VI are stitched to form a stitched image of areas I and VI. The far-focus images of the other seven areas may be also stitched in sequence to form a stitched image. In process S15, by using the reference image as a reference basis, the stitched image is further processed to obtain the target reconstructed image. Since the target reconstructed image is formed by stitching the plurality of far-focus images with clear details, the resolution of the target reconstructed image may be high and the details may be clear, which may truly reflect the photographing target scene 200 and may not introduce poor visual effect under some scenes.

In the image processing method of the gimbal system 100 of embodiments of the present disclosure, the zoom lens 20 may be controlled to capture the reference image at the first focal range. The zoom lens 20 may then be controlled to capture the plurality of far-focus images in different photographing ranges at the second focal range. The plurality of far-focus images may be stitched into the stitched image. The reference image and the stitched image may be processed to obtain the target reconstructed image. Since the resolution of the plurality of far-focus images captured at the second focal range is high, the resolution of the target reconstructed image may be high. By using the image processing method of the present disclosure, on one aspect, the obtained target reconstructed image may have a relatively small difference from the actual scene. That is, the target reconstructed image may truly reflect the target scene 200. On another aspect, the visual effect under the target scene 200 may be relatively nice.

In some embodiments, photographing ranges of at least two of the plurality of far-focus images in the different photographing ranges may be neighboring to each other in a horizontal direction. Photographing ranges of at least two of the plurality of far-focus images in the different photographing ranges may be neighboring to each other in a vertical direction.

When the photographing ranges of the at least two of the far-focus images are adjacent to each other or overlap in the horizontal direction, the photographing ranges of the at least two of the far-focus images in the different photographing ranges may be neighboring to each other. In addition, when the photographing ranges of the at least two of the far-focus images are adjacent to each other or overlap in the vertical direction, the photographing ranges of the at least two of the far-focus images in different photographing ranges may be neighboring to each other. As shown in FIG. 4, the nine far-focus images are continued to be taken as an example. Photographing ranges of two of the far-focus images of neighboring areas are neighboring to each other in the horizontal direction or the vertical direction. For example, the photographing ranges of the far-focus images of area I and area II are neighboring to each other in the horizontal direction, and the photographing ranges of the far-focus images of area I and area IV are neighboring to each other in the vertical direction. When the photographing ranges of the at least two of the far-focus images are adjacent to each other or overlap in the horizontal direction or the vertical direction, feature points of an adjacent boundary or an overlap area of the neighboring two of the far-focus images may be extracted, and then the two of the far-focus images may be stitched according to a manner of matching feature points. As shown in FIG. 5, stitching the far-focus image of area I and the far-focus image of area IV is taken as an example. Area X and area Y of the far-focus image of area I include feature points (indicated by black dots). Area X′ and area Y′ of the far-focus image of area IV include feature points (indicated by black dots). By matching the feature points of area X and area X′ and matching the feature points of area Y and area Y′, feature point pairs may be obtained between the far-focus image of area I and the far-focus image of area IV. Then, the feature point pairs are matched, and the far-focus image of area I and the far-focus image of area IV may be stitched by using an algorithm to obtain the stitched image of area I and area IV. By analogy, the far-focus images of the other seven areas may be stitched in sequence to form the stitched image. Since the photographing ranges of the at least two of the plurality of far-focus images are neighboring to each other in the horizontal direction and the vertical direction, when the plurality of far-focus images in the different photographing ranges are stitched into the stitched image, the neighboring two of the far-focus images may not discontinue (the target scene 200 not continuous) in the horizontal direction and the vertical direction.

In some embodiments, the plurality of far-focus images in the different photographing ranges may form an m*n matrix, where m is greater than or equal to 2, n is greater than or equal to 2, and m and n are integers.

When the size of the reference image is determined, the focus areas of different photographing ranges may be selected according to a detail quantity of the target scene 200. For example, m may be an integer of 2, 3, 4, 10, 20, 100, etc., and n may be an integer of 2, 6, 8, 15, 25, 80, etc. The greater m and n are, the greater the amount of detail of the target scene 200 is. That is, the target scene 200 may be more likely to be reproduced. For example, if the target reconstructed image with four clear areas of upper left, upper right, lower left, and lower right needs to be obtained, the zoom lens 20 may capture the far-focus images of the four areas at the second focal range. As such, the four far-focus images distributed in a 2*2 matrix may be obtained. For example, as shown in FIG. 4, if the target reconstructed image with the clear nine areas needs to be obtained, the zoom lens 20 is focused on the nine areas in sequence at the second focal range and captures the far-focus images of the nine areas to obtain the nine far-focus images distributed in a 3*3 matrix.

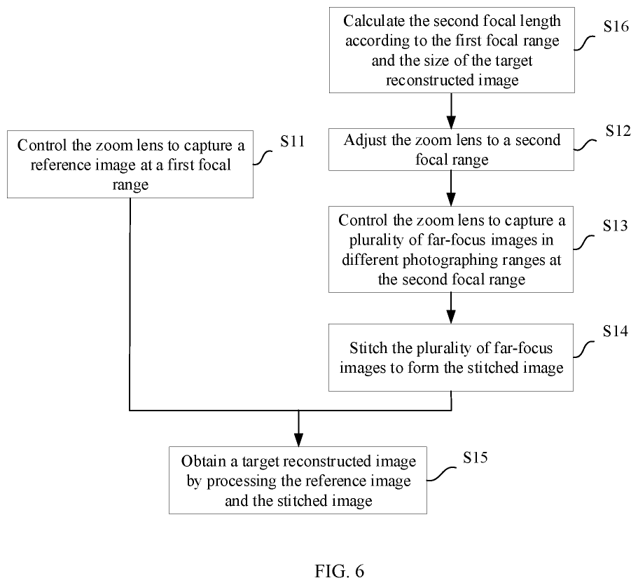

As shown in FIG. 6, in some embodiments, before process S12, the image processing method further includes the following processes.

At S16, the second focal range is calculated according to the first focal range and the size of the target reconstructed image.

In some embodiments, the size of the target reconstructed image may be determined by one or a plurality of parameters of dimension, resolution, etc. The size of the target reconstructed image may be consistent with the size of the reference image or larger than the size of the reference image. When the size of the target reconstructed image is determined, the resolution of the target reconstructed image may be further determined. The resolution of the target reconstructed image may be set according to the requirement of the display image or the resolution of the reference image. According to the resolution and the size of the target reconstructed image, the second focal range may be calculated based on the first focal range. As such, the second focal range corresponding to the relatively large lens focal length may be obtained.

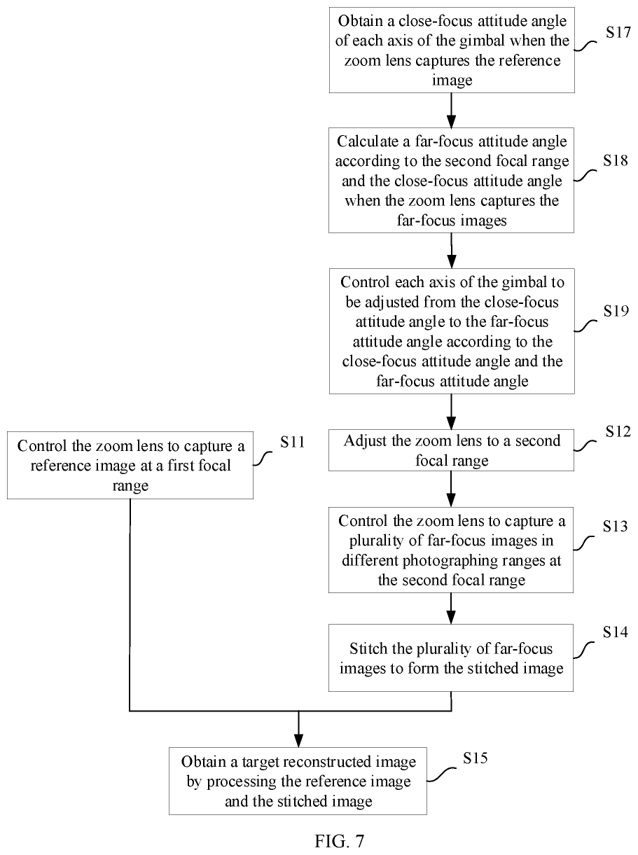

As shown in FIG. 7, in some embodiments, the gimbal 10 includes one or more axes. The image processing method further includes the following processes.

At S17, a close-focus attitude angle of each axis of the gimbal 10 when the zoom lens 20 captures the reference image is obtained.

At S18, a far-focus attitude angle is calculated according to the second focal range and the close-focus attitude angle when the zoom lens 20 captures the far-focus images.

At S19, each axis of the gimbal 10 is controlled to be adjusted from the close-focus attitude angle to the far-focus attitude angle according to the close-focus attitude angle and the far-focus attitude angle.

In some embodiments, in connection with FIG. 1, the three-axis gimbal 10 is taken as an example. When the zoom lens 20 captures the reference image, the attitude angles of the gimbal 10 may be represented by a yaw axis attitude angle, a roll axis attitude angle, and a pitch axis attitude angle. The close-focus attitude angle of the yaw axis, the close-focus attitude angle of the roll axis, and the close-focus attitude angle of the pitch axis may be obtained in sequence. According to the second focal range, the far-focus attitude angle (far-focus attitude angle of the yaw axis, far-focus attitude angle of the roll axis, and far-focus attitude angle of the pitch axis) of the gimbal 10 may be determined when the zoom lens 20 captures the far-focus images, and the direction and the angle that need to be rotated when the gimbal 10 is adjusted from the near-focus attitude angle to the far-focus attitude angle may be calculated. In some embodiments, the angle and direction needed to rotate may be calculated by a formula. For example, the close-focus attitude angle and the far-focus attitude angle represented by the yaw axis attitude angle, the roll axis attitude angle, and the pitch axis attitude angle may be converted to be represented by quaternion to quickly calculate the angle and the direction needed to rotate. In another example, the angle and the direction needed to rotate may be obtained by inquiring a table. The angle and the direction needed to rotate may be repeatedly measured when the close-focus attitude angle is adjusted to any far-focus attitude angle to obtain a correspondence table of the close-focus attitude angle and the far-focus attitude angle. As such, after the close-focus attitude angle of the zoom lens 20 is obtained, the angle and the direction needed to rotate may be directly obtained by inquiring the correspondence table of the close-focus attitude angle and the far-focus attitude angle to adjust the close-focus attitude angle of each axis of the gimbal 10 to the far-focus attitude angle.

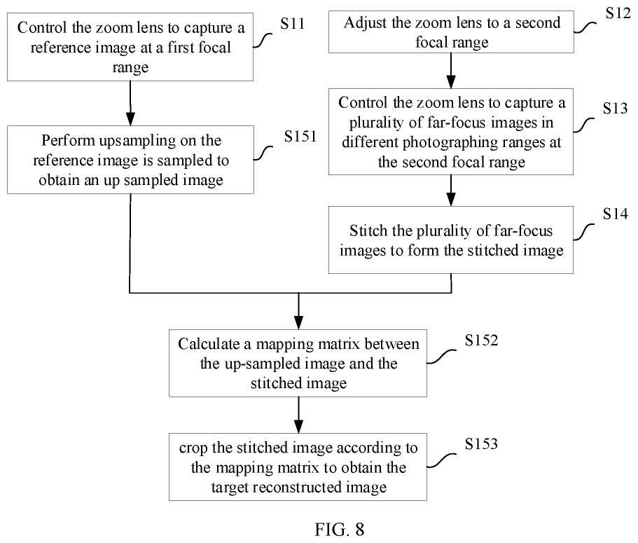

As shown in FIG. 8, in some embodiments, processing the reference image and the stitched image to obtain the target reconstructed image (S15) includes performing upsampling on the reference image to obtain an upsampled image (S151), calculating a mapping matrix between the upsampled image and the stitched image (S152), and cropping the stitched image according to the mapping matrix to obtain the target reconstructed image (S153).

In some embodiments, since the resolution of the finally obtained target reconstructed image is higher than the resolution of the reference image, the reference image may be enlarged. In process S151, the upsampling is performed on the reference image. That is, based on the reference image, a suitable interpolation algorithm may be used to insert new pixels between pixels to obtain a sampled image. The interpolation algorithm may include a nearest neighbor interpolation algorithm, a bilinear interpolation algorithm, a mean interpolation algorithm, a median interpolation algorithm, etc. The nearest neighbor interpolation algorithm is taken as an example. In four neighboring pixels of a to-be-determined pixel, a grayscale of a neighboring pixel closest to the to-be-determined pixel may be assigned to the to-be-determined pixel to achieve rapid interpolation. In addition, after the sampled image interpolated is obtained, a mapping relationship between corresponding points of the sampled image and the stitched image may be further calculated. That is, the mapping matrix of the sampled image and the stitched image may be calculated. Since the stitched image is formed by stitching the plurality of far-focus images, the size of the stitched image may be larger than the size of the sampled image. A different pixel area of the sampled image and the stitched image may be determined according to the mapping matrix of the sampled image and the stitched image. Cropping may be performed on the stitched image according to the mapping matrix to remove redundant portions of the sampled image and the stitched image. In some other embodiments, according to the size of the target reconstructed image, only the far-focus image having the same size as the target reconstructed image may be stitched, and the stitched image may not need to be cropped to obtain the target reconstructed image. As shown in FIG. 4, only the far-focus images of the center areas (the focus areas including area II, area IV, area V, area VI, and area VIII) may be stitched. The obtained stitched image may be used to reconstruct the target reconstructed image.

In some embodiments, the mapping matrix may include a homography matrix or an affine transformation matrix. The homography matrix of the sampled image and the reference image may be obtained by using FindHomography function to map coordinates of pixel points of the sampled image into coordinates of pixel points of the stitched image. According to the affine transformation matrix of the sampled image and the reference image, an affine transformation may be performed on the sampled image to realize the linear transformation of the sampled image and the stitched image.

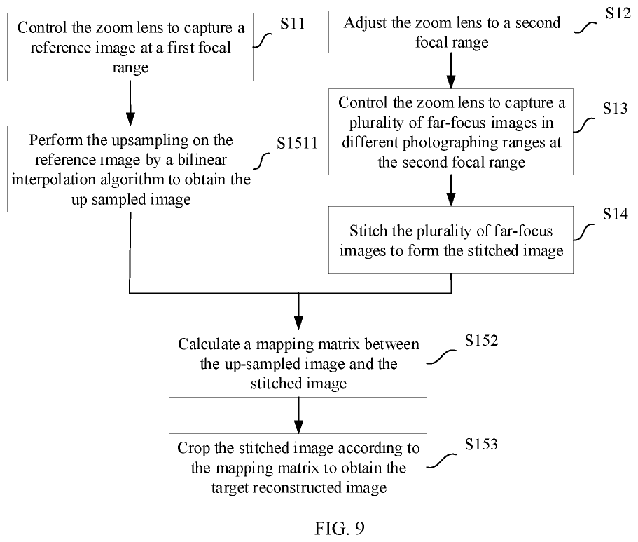

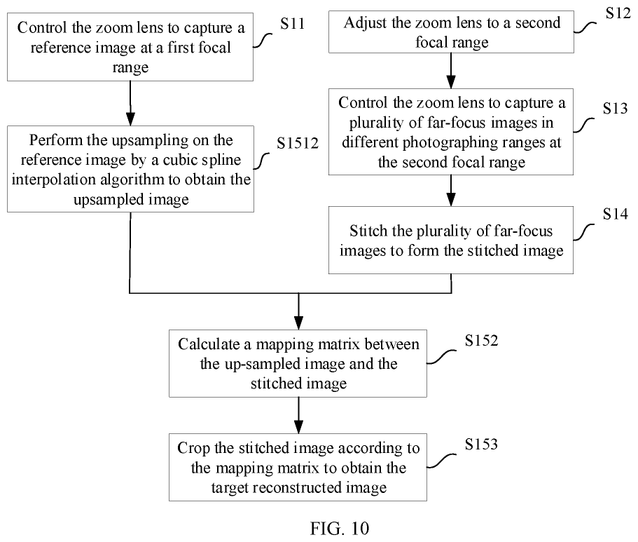

As shown in FIG. 9 and FIG. 10, in some embodiments, performing upsampling on the reference image to obtain the upsampled image (S151) includes performing the upsampling on the reference image by a bilinear interpolation algorithm to obtain the upsampled image (S1511) or performing the upsampling on the reference image by a cubic spline interpolation algorithm to obtain the upsampled image (S1512).

In some embodiments, the interpolation algorithm of the upsampling may include the bilinear interpolation algorithm and the cubic spline interpolation algorithm. For the bilinear interpolation algorithm, linear interpolation may be performed in each of the horizontal direction and the vertical direction of the reference image. For the cubic spline interpolation algorithm, a three-moment equation and a first boundary condition may be used to perform piecewise cubic interpolation on the reference image. Compared to the nearest neighbor interpolation algorithm, the sampled image obtained by using the bilinear interpolation algorithm or the cubic spline interpolation algorithm to perform the upsampling on the reference image may be less prone to distortion.

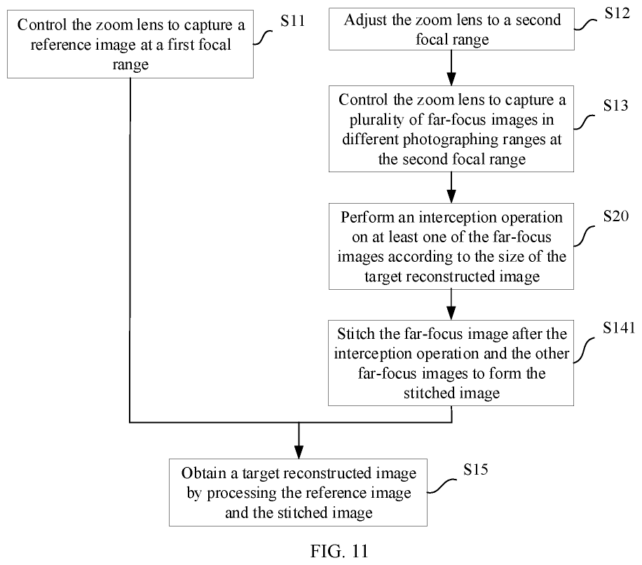

As shown in FIG. 11, in some embodiments, the image processing method further includes the following processes.

At S20, an interception operation is performed on at least one of the far-focus images according to the size of the target reconstructed image.

Further, as shown in FIG. 11, stitching the plurality of far-focus images to form the stitched image (S14) includes stitching the far-focus image after the interception operation and the other far-focus images to form the stitched image (S141).

When the size of the stitched image formed by stitching the plurality of far-focus images is larger than the size of the reconstructed image, the interception operation may need to be performed on the plurality of far-focus images. In some embodiments, before the plurality of far-focus images in the different photographing ranges are stitched into the image, the difference between the total size of the plurality of far-focus images and the size of the target reconstructed image may be calculated, and the pixel area that is more than the target reconstructed image may be calculated. That is, the area of the far-focus image that needs to be intercepted may be calculated, and the interception operation may be performed on the far-focus images that need to be intercepted. After the redundant pixel area is intercepted, the intercepted far-focus images and the intercepted far-focus images that are not intercepted may be stitched into the stitched image. As such, the target reconstructed image may be obtained without cropping the stitched image.

As shown in FIG. 1, embodiments of the present disclosure provide the gimbal system 100. The image processing method of embodiments of the present disclosure may be applied in the gimbal system 100. The gimbal system 100 includes the gimbal 10, the zoom lens 20 carried by the gimbal 10, and a processor 30. The processor 30 may be configured to control the zoom lens 10 to capture the reference image at the first focal range. The first focal range is the expected photographing focal range of the user. The processor 30 may be further configured to adjust the zoom lens 20 to the second focal range, and control the zoom lens 20 to capture the plurality of far-focus images in the different photographing ranges at the second focal range. The lens focal length corresponding to the second focal range may be greater than the lens focal length corresponding to the first focal range. The processor 30 may be further configured to stitch the plurality of far-focus images to form the stitched image and process the reference image and the stitched image to obtain the target reconstructed image. In connection with FIG. 2, the processor 30 is configured to implement processes S11, S12, S13, S14, and S15.

In some embodiments, the attitude of the gimbal 10 may follow the motion of the imaged object. The gimbal 10 may include one or a plurality of axes. When the gimbal 10 only includes one axis, the gimbal 10 is a single-axis gimbal. When the gimbal 10 includes a plurality of axes, the gimbal 10 is a multi-axis gimbal. The multi-axis gimbal 10 may include a two-axis gimbal, for example, the gimbal including the yaw axis and the roll axis, or the gimbal including the yaw axis and the pitch axis. The multi-axis gimbal 10 may include a three-axis gimbal including the yaw axis, the roll axis, and the pitch axis. In embodiments of the present disclosure, the three-axis gimbal is described as an example of the gimbal 10.

The zoom lens 20 may change the focal length within a certain photographing range. With different focal lengths, the zoom lens 20 may include the view angles of different sizes, the field of views of different sizes, and the photographing ranges of different sizes. As such, the photographing ranges of the scenes covered by the images captured at different focal lengths may be different (i.e., photographing ranges are different). In some embodiments, the zoom lens 20 may include the optical zoom lens, the digital zoom lens, or the combination of the plurality of types of zoom lenses. The zoom lens 20 may be carried by the gimbal 10. Thus, the zoom lens 20 may follow the imaged object in real-time. In some embodiments, the zoom lens 20 may rotate relative to the yaw axis, the roll axis, and the pitch axis of the gimbal 10. When one or two axes of the gimbal 10 are locked, the zoom lens 20 may rotate following the other one or two axes. For example, when the roll axis and the pitch axis are locked, the zoom lens 20 may only rotate relative to the yaw axis. The zoom lens 20 of embodiments of the present disclosure may capture an image at the first focal range or switch from the first focal range to the second focal range to capture an image at the second focal range. The first focal range may include a photographing focal length expected by the user. Within the first focal range, the corresponding lens focal length is relatively small, the view angle photographed by the zoom lens 20 may be relatively large, the main object photographed by the zoom lens 20 may be relatively small, and the depth of field photographed by the zoom lens 20 may be relatively long. The lens focal length corresponding to the second focal range may be greater than the lens focal length corresponding to the first focal range. Within the second focal range, the lens focal length corresponding to the second focal range may be relatively large, the view angle photographed by the zoom lens 20 may be relatively small, the main object photographed by the zoom lens 20 may be relatively large, and depth of field photographed by the zoom lens 20 may be relatively short.

In connection with FIG. 3, in the image processing method of embodiments of the present disclosure, the to-be-imaged object, for example, a person, an animal, a scene, etc., is determined first in the target scene 200. Then, the processor 30 may be configured to control the zoom lens 20 to capture the reference image at the first focal range. The view angle of the reference image may be relatively large, and the main object of the reference image may be relatively small and have a relatively low resolution. Subsequently, the processor 30 may be configured to control the zoom lens 20 to capture the plurality of far-focus images in different photographing ranges at the second focal range. In some embodiments, the plurality of far-focus images may include two or more images. In addition, the different photographing ranges may represent that the zoom lens 20 may focus on a plurality of different areas in the target scene 200 to obtain clear images of the plurality of different areas. As shown in FIG. 4, the zoom lens 20 is focused on the nine areas of the target scene 200 at the second focal range. For example, in area I, the zoom lens 20 is focused on the sun, and in area VI, the zoom lens 20 is focused on a peak of a third mountain from the left. The lens focal length of the zoom lens 20 focused on each area may be the same or slightly different but within the photographing range of the second focal range. After the zoom lens 20 captures at the second focal range, nine far-focus images of nine different photographing ranges may be obtained. Each far-focus image may display detail of at least one area of the target scene 200. After obtaining the plurality of far-focus images, the processor 30 may be configured to stitch the plurality of far-focus images to form the stitched image. As shown in FIG. 5, the far-focus image of area I and the far-focus image of area VI are stitched to form the stitched image of areas I and VI. The far-focus images of the other seven areas are stitched in sequence to form the stitched image. By using the reference image as a reference basis, the processor may be configured to further process the stitched image to obtain the target reconstructed image. Since the target reconstructed image is formed by stitching the plurality of far-focus images with clear details, the resolution of the target reconstructed image may be high and the details are clear, which may truly reflect the photographing target scene 200 and may not introduce poor visual effect under some scenes.

In the gimbal system 100 of embodiments of the present disclosure, the processor 30 may be configured to control the zoom lens 20 to capture the reference image at the first focal range and then to capture the plurality of far-focus images in different photographing ranges at the second focal range. The processor 30 may be subsequently configured to stitch the plurality of far-focus images to form the stitched image and process the reference image and the stitched image to obtain the target reconstructed image. Since the resolution of the far-focus images captured at the second focal range is high, the resolution of the target reconstructed image may be high. By using the gimbal system 100 of the present disclosure, on one aspect, the obtained target reconstructed image may have a relatively small difference from the actual scene. That is, the target reconstructed image may truly reflect the target scene 200. On another aspect, the visual effect under the target scene 200 may be relatively nice.

In some embodiments, the photographing ranges of the at least two of the plurality of far-focus images in the different photographing ranges may be neighboring to each other in the horizontal direction. The photographing ranges of the at least two of the plurality of far-focus images in the different photographing ranges may be neighboring to each other in the vertical direction.

When the photographing ranges of the at least two of the far-focus images are adjacent to each other or overlap in the horizontal direction, the photographing ranges of the at least two of the far-focus images in the different photographing ranges may be neighboring to each other. In addition, when the photographing ranges of the at least two of the far-focus images are adjacent to each other of overlap in the vertical direction, the photographing ranges of the at least two of the far-focus images in different photographing ranges may be neighboring to each other. As shown in FIG. 4, the nine far-focus images are continued to be taken as the example. The photographing ranges of the two of the far-focus images of neighboring areas are neighboring to each other in the horizontal direction or the vertical direction. For example, the photographing ranges of the far-focus images of area I and area II are neighboring to each other in the horizontal direction, and the photographing ranges of the far-focus images of area I and area IV are neighboring to each other in the vertical direction. When the photographing ranges of the at least two of the far-focus images are adjacent to each other or overlap in the horizontal direction or the vertical direction, the feature points of the adjacent boundary or the overlap area of the neighboring two of the far-focus images may be extracted, and then the two of the far-focus images may be stitched according to a manner of matching the feature points. As shown in FIG. 5, stitching the far-focus image of area I and the far-focus image of area IV is taken as an example. Area X and area Y of the far-focus image of area I include the feature points (indicated by black dots). Area X′ and area Y′ of the far-focus image of area IV include the feature points (indicated by black dots). By matching the feature points of area X and area X′ and matching the feature points of area Y and area Y′, the feature point pairs may be obtained between the far-focus image of area I and the far-focus image of area IV. Then, the feature point pairs are matched, and the far-focus image of area I and the far-focus image of area IV may be formed by stitching using an algorithm to obtain the stitched image of area I and area IV. By analogy, the far-focus images of the other seven areas may be stitched in sequence to form the stitched image. Since the photographing ranges of the at least two of the plurality of far-focus images are neighboring to each other in the horizontal direction and the vertical direction, when the plurality of far-focus images in the different photographing ranges are stitched to form the stitched image, the neighboring two of the far-focus images may not be discontinued (the target scene 200 not continuous) in the horizontal direction and the vertical direction.

In some embodiments, the plurality of far-focus images in the different photographing ranges may form the m*n matrix, where m is greater than or equal to 2, n is greater than or equal to 2, and m and n are integers.

When the size of the reference image is determined, the focus areas of different photographing ranges may be selected according to a detail quantity of the target scene 200. For example, m may be the integer of 2, 3, 4, 10, 20, 100, etc., and n may be the integer of 2, 6, 8, 15, 25, 80, etc. The greater m and n are, the greater the amount of detail of the target scene 200 is. That is, the target scene 200 may be more likely to be reproduced. For example, if the target reconstructed image with four clear areas of upper left, upper right, lower left, lower right needs to be obtained, the zoom lens 20 may capture the far-focus images of the four areas at the second focal range. As such, the four far-focus images distributed in the 2*2 matrix may be obtained. For example, as shown in FIG. 4, if the target reconstructed image with the clear nine areas needs to be obtained, the zoom lens 20 is focused on the nine areas in sequence at the second focal range and captures the far-focus images of the nine areas to obtain the nine far-focus images distributed in the 3*3 matrix.

In some embodiments, the processor 30 may be further configured to calculate the second focal range according to the first focal range and the size of the target reconstructed image. That is, the processor 30 may be further configured to implement process S16.

In some embodiments, the size of the target reconstructed image may be determined by one or a plurality of parameters of the dimension, the resolution, etc. The size of the target reconstructed image may be consistent with the size of the reference image or larger than the size of the reference image. When the size of the target reconstructed image is determined, the resolution of the target reconstructed image may be further determined. The resolution of the target reconstructed image may be set according to the requirement of the display image or the resolution of the reference image. According to the resolution and the size of the target reconstructed image, the second focal range may be calculated based on the first focal range. As such, the second focal range corresponding to the relatively large lens focal length may be obtained.

In some embodiments, the gimbal 10 may include one or more axes. The processor 30 may be further configured to obtain the close-focus attitude angle of each axis of the gimbal 10 when the zoom lens 20 captures the reference image, calculate a far-focus attitude angle when the zoom lens 20 captures the far-focus images are calculated according to the second focal range and the close-focus attitude angle, and control each axis of the gimbal 10 to be adjusted from the close-focus attitude angle to the far-focus attitude angle according to the close-focus attitude angle and the far-focus attitude angle. In connection with FIG. 7, that is, the processor 30 is configured to implement process S17, S18, and S19.

In some embodiments, in connection with FIG. 1, the three-axis gimbal 10 is taken as an example. When the zoom lens 20 captures the reference image, the attitude angles of the gimbal 10 may be represented by the yaw axis attitude angle, the roll axis attitude angle, and the pitch axis attitude angle. The close-focus attitude angle of the yaw axis, the close-focus attitude angle of the roll axis, and the close-focus attitude angle of the pitch axis may be obtained in sequence. According to the second focal range, the far-focus attitude angle (far-focus attitude angle of the yaw axis, far-focus attitude angle of the roll axis, and far-focus attitude angle of the pitch axis) of the gimbal 10 may be determined when the zoom lens 20 captures the far-focus images, and the direction and the angle that need to be rotated when the gimbal 10 is adjusted from the near-focus attitude angle to the far-focus attitude angle may be calculated. For example, the angle and the direction that need to be rotated may be calculated by a formula. For example, the close-focus attitude angles and the far-focus attitude angles represented by the yaw axis attitude angle, the roll axis attitude angle, and the pitch axis attitude angle may be converted to be represented by quaternion to quickly calculate the angle and the direction needed to rotate. In another example, the angle and the direction that need to be rotated may be obtained by inquiring a table. The angle and the direction that need to rotate may be repeated measured when the close-focus attitude angle is adjusted to any far-focus attitude angle to obtain a correspondence table of the close-focus attitude angle and the far-focus attitude angle. As such, after the close-focus attitude angle of the zoom lens 20 is obtained, the angle and the direction that need to be rotated may be directly obtained by inquiring the correspondence table of the close-focus attitude angle and the far-focus attitude angle to adjust the close-focus attitude angle of each axis of the gimbal 10 to the far-focus attitude angle.

In some embodiments, the processor 30 may be further configured to perform the upsampling on the reference image to obtain the upsampled image, calculate the mapping matrix between the upsampled image and the stitched image, and cropping the stitched image according to the mapping matrix to obtain the target reconstructed image. In connection with FIG. 8, that is, the processor 30 is further configured to implement process S151, S152, and S153.

In some embodiments, since the resolution of the finally obtained target reconstructed image is higher than the resolution of the reference image, the reference image may be enlarged. The processor 30 may be configured to perform upsampling on the reference image. That is, based on the reference image, a suitable interpolation algorithm may be used to insert new pixels among pixels to obtain a sampled image. The interpolation algorithm may include the nearest neighbor interpolation algorithm, the bilinear interpolation algorithm, the mean interpolation algorithm, the median interpolation algorithm, etc. The nearest neighbor interpolation algorithm is taken as an example. In four neighboring pixels of a to-be-determined pixel, the grayscale of the neighboring pixel closest to the to-be-determined pixel may be assigned to the to-be-determined pixel to achieve rapid interpolation. In addition, after the sampled image interpolated is obtained, the mapping relationship between the corresponding points of the sampled image and the stitched image may be further calculated. That is, the mapping matrix of the sampled image and the stitched image may be calculated. Since the stitched image is formed by stitching the plurality of far-focus images, the size of the stitched image may be larger than the size of the sampled image. The different pixel areas of the sampled image and the stitched image may be determined. The cropping may be performed on the stitched image according to the mapping matrix to remove the redundant portions of the sampled image in the stitched image. In some other embodiments, according to the size of the target reconstructed image, only the far-focus image having the same size as the target reconstructed image may be stitched, and the stitched image may not need to be cropped to obtain the target reconstructed image. As shown in FIG. 4, only the far-focus images of the center areas (the focus areas including area II, area IV, area V, area VI, and area VIII) may be stitched. The obtained stitched image may be used to reconstruct the target reconstructed image.

In some embodiments, the mapping matrix may include the homography matrix or the affine transformation matrix. The homography matrix of the sampled image and the reference image may be obtained by using FindHomography function to map the coordinates of pixel points of the sampled image into the coordinates of pixel points of the stitched image. According to the affine transformation matrix of the sampled image and the reference image, the affine transformation may be performed on the sampled image to realize the linear transformation of the sampled image and the stitched image.

In some embodiments, the processor may be further configured to perform the upsampling on the reference image by the bilinear interpolation algorithm to obtain the upsampled image or perform the upsampling on the reference image by the cubic spline interpolation algorithm to obtain the upsampled image. In connection with FIG. 9 and FIG. 10, the processor 30 may be further configured to implement process S1511 or S1512.

In some embodiments, the interpolation algorithm of the upsampling may include the bilinear interpolation algorithm and the cubic spline interpolation algorithm. For the bilinear interpolation algorithm, the linear interpolation may be performed in each of the horizontal direction and the vertical direction of the reference image. For the cubic spline interpolation algorithm, the three-moment equation and the first boundary condition may be used to perform the piecewise cubic interpolation on the reference image. Compared to the nearest neighbor interpolation algorithm, the sampled image obtained by using the bilinear interpolation algorithm or the cubic spline interpolation algorithm to perform the upsampling on the reference image may be less prone to distortion.

In some embodiments, the processor 30 may be further configured to perform the interception operation on the at least one of the far-focus images according to the size of the target reconstructed image and stitch the far-focus image after the interception operation and the other far-focus images to form the stitched image. In connection with FIG. 11, that is, the processor 30 is further configured to implement processes S20 and S141.

When the size of the stitched image formed by stitching the plurality of far-focus images is greater than the size of the reconstructed image, the interception operation may need to be performed on the plurality of far-focus images. In some embodiments, before the plurality of far-focus images in the different photographing ranges are stitched to form the image, the difference between the total size of the plurality of far-focus images and the size of the target reconstructed image may be calculated, and the pixel area that is more than the target reconstructed image may be calculated. That is, the area of the far-focus image needed to be intercepted may be calculated, and the interception operation may be performed on the far-focus images that need to be intercepted. After the redundant pixel area is intercepted, the intercepted far-focus images and the far-focus images that are not intercepted may be stitched to form the stitched image. As such, As such, the target reconstructed image may be obtained without cropping the stitched image.

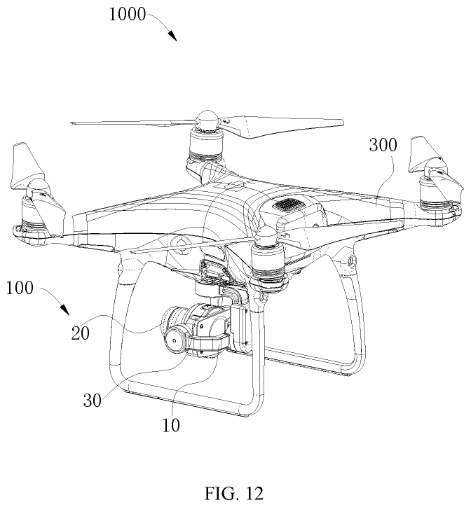

As shown in FIG. 12, embodiments of the present disclosure provide an unmanned aerial vehicle (UAV) 1000. The UAV 1000 includes the gimbal system 100 and a vehicle body 300. The gimbal system 100 is arranged at the vehicle body 300.

The UAV 1000 of embodiments of the present disclosure may include a four-rotor aircraft, a six-rotor aircraft, an eight-rotor aircraft, etc., which is not limited here. In embodiments of the present disclosure, the four-rotor aircraft is described as an example of the UAV 1000, which may carry the gimbal system 100. The gimbal 10 is fixedly connected to the vehicle body 300. The zoom lens 20 is mounted at the gimbal 10. The zoom lens 20 may be configured to photograph or record when the UAV 1000 flies or hovers.

The UAV 1000 of embodiments of the present disclosure may control the zoom lens 20 to capture the reference image at the first focal range, then capture the plurality of far-focus images in different photographing ranges at the second focal range, subsequently stitch the plurality of far-focus images to form the stitched image, and process the reference image and the stitched image to obtain the target reconstructed image. Since the resolution of the far-focus image captured at the second focal range is high, the resolution of the target reconstructed image may be high. By using the UAV 1000 of the present disclosure, on one aspect, the obtained target reconstructed image may have a relatively small difference from the actual scene. That is, the target reconstructed image may truly reflect the target scene 200. On another aspect, the visual effect under the target scene 200 may be relatively nice.

In the description of this specification, referring to the terms “certain embodiments,” “one embodiment,” “some embodiments,” “exemplary embodiments,” “examples,” “specific examples,” or “some examples,” the description means that specific features, structures, materials, or characteristics described in connection with embodiments or examples are included in at least one embodiment or example of the present disclosure. In this specification, the schematic description of the above terms does not necessarily refer to a same embodiment or example. The described specific features, structures, materials, or characteristics may be stitched in any suitable manner in any one or more embodiments or examples.

Any process or method description described in the flowchart or described in other manners herein may be understood as a module, a segment, or a part of codes that include one or more executable instructions used to execute specific logical functions or steps of the process. The scope of selected embodiments of the present disclosure may include additional executions, which may not be in the order shown or discussed, including executing functions in a substantially simultaneous manner or in a reverse order according to the functions involved. Those skilled in the art to which embodiments of the present disclosure belong should understand such executions.

The logic and/or steps represented in the flowchart or described in other manners herein, for example, may be considered as a sequenced list of executable instructions for executing logic functions, and may be executed in any computer-readable medium, for instruction execution systems, devices, or apparatuses (e.g., computer-based systems, including systems of processors, or other systems that can fetch instructions from instruction execution systems, devices, or, apparatuses and execute the instructions) to use, or used in connection with these instruction execution systems, devices, or apparatuses. For this specification, a “computer-readable medium” may include any device that can contain, store, communicate, propagate, or transmit a program for use by the instruction execution systems, devices, or apparatuses, or in combination with these instruction execution systems, devices, or apparatuses. More specific examples (e.g., non-exhaustive list) of the computer-readable medium include an electrical connection (e.g., electronic device) with one or more wiring, a portable computer disk case (e.g., magnetic device), a random access memory (RAM), a read-only memory (ROM), an erasable and editable read-only memory (EPROM or flash memory), a fiber optic device, and a portable compact disk read-only memory (CDROM). In addition, the computer-readable medium may even be paper or other suitable media on which the program may be printed, because, for example, the program may be obtained digitally by optically scanning the paper or other media, and then editing, interpreting, or processing by other suitable manners when necessary. Then, the program may be saved in the computer storage device.

Each part of the present disclosure may be executed by hardware, software, firmware, or a combination thereof. In embodiments of the present disclosure, multiple steps or methods may be executed by software or firmware stored in a memory and executed by a suitable instruction execution system. For example, when the steps or methods are executed by the hardware, the hardware may include a discrete logic circuit of a logic gate circuit for performing logic functions on data signals, an application-specific integrated circuit with a suitable combinational logic gate circuit, a programmable gate array (PGA), a field-programmable gate array (FPGA), etc.

Those of ordinary skill in the art can understand that all or part of the steps carried in the above implementation method may be completed by a program instructing relevant hardware. The program may be stored in a computer-readable storage medium. When the program is executed, one of the steps of method embodiments or a combination thereof may be realized.

In addition, functional units of embodiments of the present disclosure may be integrated into one processing module, or the units may exist alone physically, or two or more units may be integrated into one module. The above-mentioned integrated module may be implemented in a form of a hardware or software functional module. If the integrated module is implemented in the form of a software function module and sold or used as an independent product, the integrated module may also be stored in a computer-readable storage medium. The storage medium may include a read-only memory, a magnetic disk, an optical disk, etc.

Although embodiments of the present disclosure are shown and described above, described embodiments are exemplary and should not be understood as a limitation of the present disclosure. Those of ordinary skill in the art may perform changes, modifications, replacements, and variations on embodiments of the present disclosure within the scope of the present disclosure.

What is claimed is:

1. An image processing method comprising:
controlling a zoom lens carried by a gimbal to capture a reference image at a first focal range;
adjusting the zoom lens to a second focal range;
controlling the zoom lens to capture a plurality of far-focus images of different photographing ranges at the second focal range, a focal length of the zoom lens corresponding to the second focal range being greater than a focal length of the zoom lens corresponding to the first focal range;
stitching the plurality of far-focus images to form a stitched image; and
processing the reference image and the stitched image to obtain a target reconstructed image.

2. The method of claim 1, further comprising, before adjusting the zoom lens to the second focal range:
calculating the second focal range according to the first focal range and a size of the target reconstructed image.

3. The method of claim 1, further comprising:
obtaining a close-focus attitude angle of an axis of the gimbal, the close-focus attitude angle of the axis being an attitude angle of the axis when the zoom lens captures the reference image;
calculating a far-focus attitude angle of the axis according to the second focal range and the close-focus attitude angle, the far-focus attitude angle of the axis being an attitude angle of the axis when the zoom lens captures the far-focus images; and
controlling the axis of the gimbal to be adjusted from the close-focus attitude angle to the far-focus attitude angle.

4. The method of claim 1, wherein processing the reference image and the stitched image to obtain the target reconstructed image includes:
performing upsampling on the reference image to obtain an upsampled image;
calculating a mapping matrix between the upsampled image and the stitched image; and
performing cropping on the stitched image according to the mapping matrix to obtain the target reconstructed image.

5. The method of claim 4, wherein the mapping matrix includes a homography matrix or an affine transformation matrix.

6. The method of claim 4, wherein performing the upsampling on the reference image to obtain the upsampled image includes:
performing the upsampling on the reference image according to a bilinear interpolation algorithm or a cubic spline interpolation algorithm to obtain the upsampled image.

7. The method of claim 1, wherein:
photographing ranges of at least two of the plurality of far-focus images are neighboring to each other in a horizontal direction; and
photographing ranges of at least two of the plurality of far-focus images are neighboring to each other in a vertical direction.

8. The method of claim 1, wherein the plurality of far-focus images form an m*n matrix, each of m and n being an integer greater than or equal to 2.

9. The method of claim 1, further comprising:
performing an interception operation on at least one of the far-focus images according to a size of the target reconstructed image to obtain at least one intercepted far-focus image;
wherein stitching the plurality of far-focus images to form the stitched image includes:
stitching the at least one far-focus image and other one or more of the far-focus images to form the stitched image.

10. A gimbal system comprising:
a gimbal;
a zoom lens carried by the gimbal; and
a processor configured to:
control the zoom lens to capture a reference image at a first focal range;
adjust the zoom lens to a second focal range;
control the zoom lens to capture a plurality of far-focus images of different photographing ranges at the second focal range, a lens focal length of the zoom lens corresponding to the second focal range being greater than a lens focal length of the zoom lens corresponding to the first focal range;
stitch the plurality of far-focus images to form a stitched image; and
process the reference image and the stitched image to obtain a target reconstructed image.

11. The gimbal system of claim 10, wherein the processor is further configured to:
calculate the second focal range according to the first focal range and a size of the target reconstructed image.

12. The gimbal system of claim 10, wherein the processor is further configured to:
obtain a close-focus attitude angle of an axis of the gimbal, the close-focus attitude angle of the axis being an attitude angle of the axis when the zoom lens captures the reference image;
calculate a far-focus attitude angle of the axis according to the second focal range and the close-focus attitude angle, the far-focus attitude angle of the axis being an attitude angle of the axis when the zoom lens captures the far-focus images; and
control the axis of the gimbal to be adjusted from the close-focus attitude angle to the far-focus attitude angle.

13. The gimbal system of claim 10, wherein the processor is further configured to:
perform upsampling on the reference image to obtain an upsampled image;
calculate a mapping matrix between the upsampled image and the stitched image; and
perform cropping on the stitched image according to the mapping matrix to obtain the target reconstructed image.

14. The gimbal system of claim 13, wherein the mapping matrix includes a homography matrix or an affine transformation matrix.

15. The gimbal system of claim 13, wherein the processor is further configured to:
perform the upsampling on the reference image according to a bilinear interpolation algorithm or a cubic spline interpolation algorithm to obtain the upsampled image.

16. The gimbal system of claim 10, wherein:
photographing ranges of at least two of the plurality of far-focus images are neighboring to each other in a horizontal direction; and
photographing ranges of at least two of the plurality of far-focus images are neighboring to each other in a vertical direction.

17. The gimbal system of claim 10, wherein the plurality of far-focus images form an m*n matrix, each of m and n being an integer greater than or equal to 2.

18. The gimbal system of claim 10, wherein the processor is further configured to:
perform an interception operation on at least one of the far-focus images according to a size of the target reconstructed image to obtain at least one intercepted far-focus image; and
stitch the at least one far-focus image and other one or more of the far-focus images to form the stitched image.

19. An unmanned aerial vehicle (UAV) comprising:
a vehicle body;
a gimbal system arranged at the vehicle body and including:
a gimbal;
a zoom lens carried by the gimbal; and
a processor configured to:
control the zoom lens to capture a reference image at a first focal range;
adjust the zoom lens to a second focal range;
control the zoom lens to capture a plurality of far-focus images of different photographing ranges at the second focal range, a lens focal length of the zoom lens corresponding to the second focal range being greater than a lens focal length of the zoom lens corresponding to the first focal range;
stitch the plurality of far-focus images to form a stitched image; and
process the reference image and the stitched image to obtain a target reconstructed image.
